(19) United States
(12) Patent Application Publication
(10) Pub. No.: US 2021/0267218 A1
(43) Pub. Date: Sep. 2, 2021

(54) FOOD DOUGH BAKING DEVICE AND FOOD DOUGH BAKING METHOD

(71) Applicant: Morirobo Co., Ltd., Hamamatsu-shi, Shizuoka (JP)

(72) Inventor: Hirofumi MORI, Hamamatsu-shi, Shizuoka (JP)

(21) Appl. No.: 17/259,052

(22) PCT Filed: Jul. 12, 2019
(86) PCT No.: PCT/JP2019/027764

§ 371 Date: Jan. 8, 2021

(30) Foreign Application Priority Data
Jul. 31, 2018 (JP) 2018-143128

(51) Int. Cl. A21B 5/00; A21D 8/06; A21B 1/44; A21B 3/07

(52) U.S. Cl. CPC A21B 5/00; A21B 3/07; A21B 1/44; A21D 8/06

(57) ABSTRACT

A food dough baking device includes: a disk-shaped griddle disposed to be able to rotate about the center of a circle as a rotation center in a heated state; a dough dropper that drops different kinds of food doughs to positions spaced in the radial direction of the griddle, corresponding to the food doughs, respectively; and a dough spreader that thinly spreads, on the entire surface of the griddle, the food doughs dropped toward the griddle. In the food dough baking device, the different kinds of the food doughs are baked while being spread in a thin-disk shape on the rotating griddle by the dough spreader so that each food dough forms a layer concentrically with respect to the center of rotation of the griddle.

### TECHNICAL FIELD

The present disclosure relates to a food dough baking device and a food dough baking method, by which food dough with flowability, obtained by adding water, milk, an egg, and/or the like to wheat flour, rice flour, buckwheat flour, mung bean flour, and/or the like and by mixing the wheat flour, rice flour, buckwheat flour, mung bean flour, and/or the like with the water, milk, egg, and/or the like, is thinly baked on a rotating griddle, to produce food.

### BACKGROUND ART

Various food dough baking devices and methods for thinly baking, on a griddle, food dough with flowability, obtained by adding water and/or the like to wheat flour and/or the like and by mixing the flour and/or the like with the water and/or the like, have conventionally been proposed. For example, a machine of consecutively baking crepe as a baked crust for confectionery, described in Patent Literature 1, is a device including: a hopper to be loaded with flowable crepe dough; a dough tank into which the crepe dough in the hopper is fed; a rotation drum disposed above the dough tank a plurality of heating baking plates disposed around the rotation drum; a transfer drum that rotates in the interior of the dough tank, moves the crepe dough in the dough tank to a surface of the transfer drum, and transfers the crepe dough to the heating baking plates of the rotation drum; and a scraper that peels, from the heating baking plates, a baked crust subjected to baking.

The present inventor has proposed a crepe baking device, as described in Patent Literature 2. The crepe baking device of the present inventor includes: a disk-shaped griddle disposed to be able to rotate about the center of circle as a rotation center in a heated state; a dough dropper that drops crepe dough on the griddle; and a dough spreader that thinly spreads, on the entire surface of the griddle, the crepe dough dropped on the griddle. In the crepe baking device, the crepe dough is baked while being spread in a thin-disk shape on the rotating griddle by the dough spreader.

### CITATION LIST

### Patent Literature

Patent Literature 1: Unexamined Japanese Patent Application Kokai Publication No. 2003-230353

Patent Literature 2: Unexamined Japanese Patent Application Kokai Publication No. 2017-85967

### SUMMARY OF INVENTION

### Technical Problem

However, the conventional food dough baking devices have adopted methods in which food dough is baked on the heating baking plate of the rotation drum, the methods being completely different from methods in which food dough is baked by humans, and therefore, the devices have been incapable of realizing thinness as being achieved by hand-baked food dough and of realizing recess/projection feeling as being achieved by hand-spread food dough. In the conventional food dough baking devices, one kind of food dough that can be baked has corresponded to one piece of food, and only one taste or color has been able to be enjoyed in one piece of food.

The present disclosure was made under such circumstances, and is to provide a food dough baking device and a food dough baking method, in which food doughs can be baked so that such feeling that the food doughs are thinly hand-spread and hand-baked is reproducible, and in which a food including the different kinds of the food doughs, each forming a layer concentrically with respect to the center of rotation of a griddle, can be baked.

### Solution to Problem

A food dough baking device according to claim 1 includes: a disk-shaped griddle disposed to be able to rotate about a center of a circle as a rotation center in a heated state; a dough dropper that drops different kinds of food doughs to positions spaced in a radial direction of the griddle, corresponding to the food doughs, respectively; and a dough spreader that thinly spreads, on an entire surface of the griddle, the food doughs dropped toward the griddle, wherein the different kinds of the food doughs are baked while being spread in a thin-disk shape on the rotating griddle by the dough spreader so that each food dough forms a layer concentrically with respect to a center of rotation of the griddle.

In the food dough baking device according to claim 2, the dough dropper includes: dough tanks in which the different kinds of the food doughs can be stored based on the kinds; and a mechanism of dropping dough by kind that drops the different kinds of the food doughs stored in the dough tanks to positions spaced in a radial direction of the griddle, corresponding to the food doughs, respectively.

In the food dough baking device according to claim 3, the mechanism of dropping dough by kind includes openable and closable dough drop mouths through which the different kinds of the food doughs can be dropped to the griddle on a kind basis; and the dough drop mouths are disposed on bottom surfaces of the dough tanks to allow the dough tanks and the mechanism of dropping dough by kind to be integrally formed.

In the food dough baking device according to claim 4, the mechanism of dropping dough by kind includes a dough drop mouth opening and closing mechanism that opens or closes each dough drop mouth in conjunction with a rotation position of the griddle.

In the food dough baking device according to claim 5, including a bar-shaped cam with a bar shape that includes an eccentric rotation shaft perpendicular to a rotation shaft of the griddle and extending in a radial direction of the griddle, and that rotates in conjunction with a rotation position of the griddle, wherein the dough drop mouth opening and closing mechanism includes: a shaft portion that abuts on an outer peripheral surface of the bar-shaped cam and moves in an up-and-down manner along a corrugation of the outer peripheral surface of the bar-shaped cam; and a valve that opens or closes the dough drop mouth in conjunction with up-and-down movement of the shaft portion; and wherein the valve opens or closes the dough drop mouth in conjunction with the rotation position of the griddle.

In the food dough baking device according to claim 6, the shaft portion includes: a cam-side shaft that includes a lower end abutting on the outer peripheral surface of the bar-shaped cam, and that moves in an up-and-down manner along the corrugation of the outer peripheral surface of the bar-shaped cam; a valve-side shaft that includes a lower end on which the valve is disposed; and a stay member that includes a horizontally long bar shape, that includes one end which is swingably pivotally supported, and that includes another end on which an upper end of the cam-side shaft is pivotally supported, an upper end of the valve-side shaft being pivotally supported between both the ends; the cam-side shaft moves in an up-and-down manner in conjunction with movement of the bar-shaped cam, and the stay member swings and the valve-side shaft moves in an up-and-down manner due to up-and-down movement of the shaft by the cam; and the valve opens or closes the dough drop mouth due to up-and-down movement of the valve-side shaft.

In the food dough baking device according to claim 7, the shaft portion includes a swing amount adjustment mechanism that sets an amount of swing of the stay member with respect to an amount of up-and-down movement of the cam-side shaft; and an amount of opening or closing of the dough drop mouth varies due to setting of the swing amount adjustment mechanism.

In the food dough baking device according to claim 8, the dough tanks and the mechanism of dropping dough by kind are disposed based on each of the different kinds of the food doughs.

A food dough baking method according to claim 9 includes: dropping, toward a disk-shaped griddle disposed to be able to rotate about a center of a circle as a rotation center in a heated state, different kinds of food doughs to positions spaced in a radial direction of the griddle, corresponding to the food doughs, respectively; and baking each food dough in a thin-disk shape on the rotating griddle so that each food dough forms a layer concentrically with respect to a center of rotation of the griddle, while thinly spreading, on an entire surface of the griddle, the food dough dropped toward the griddle by a dough spreader that includes a cylindrical or columnar shape rotatable along a shaft and that is disposed to lie on a side of the dough spreader in a state in which the shaft is located in a radial direction of the griddle, and in which a predetermined spacing is disposed between the dough spreader and the griddle.

In the food dough baking method according to claim 10, the kinds of the food doughs are based on a difference in colors, tastes, flavors, materials, or combinations thereof.

### Advantageous Effects of Invention

In accordance with the present disclosure, including: a disk-shaped griddle disposed to be able to rotate about the center of a circle as a rotation center in a heated state; a dough dropper that drops the different kinds of food doughs to positions spaced in the radial direction of the griddle, corresponding to the food doughs, respectively; and a dough spreader that thinly spreads, on the entire surface of the griddle, the food doughs dropped toward the griddle, wherein the different kinds of the food doughs are baked while spreading the food doughs in a thin-disk shape on the rotating griddle by the dough spreader so that each food dough forms a layer concentrically with respect to the center of rotation of the griddle, whereby the food doughs can be baked so that such feeling that the food doughs are thinly hand-spread and hand-baked is reproducible, and a food including the different kinds of the food doughs, each forming a layer concentrically with respect to the center of the rotation of the griddle, can be baked,

### BRIEF DESCRIPTION OF DRAWINGS

FIG. 1 is a perspective view illustrating an example of a food dough baking device according to the present disclosure;

FIG. 2 is an explanatory diagram illustrating the dough dropper of the food dough baking device;

FIG. 3 is an explanatory diagram illustrating the back side of the food dough baking device;

FIG. 4 is an explanatory diagram illustrating the dough drop mouth opening and closing mechanism of the food dough baking device;

FIG. 5 is an explanatory diagram illustrating operation of the dough dropper of the food dough baking device; and

FIG. 6 is an explanatory diagram illustrating operation of the food dough baking device.

### DESCRIPTION OF EMBODIMENTS

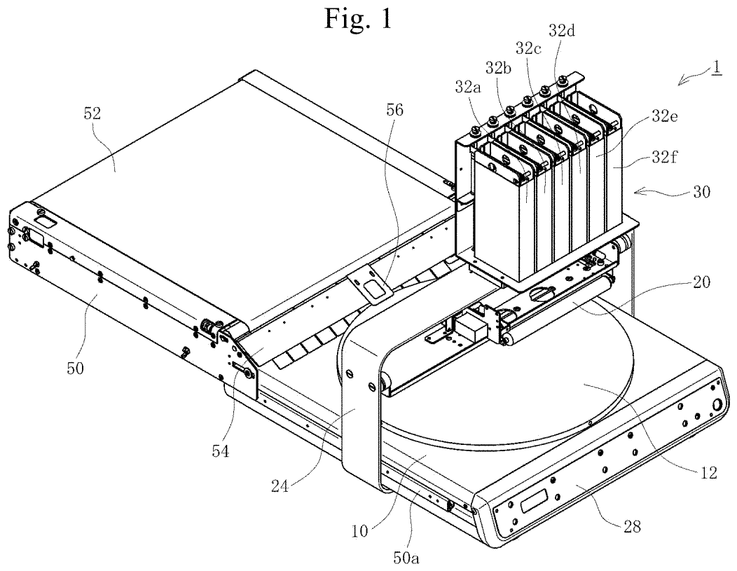

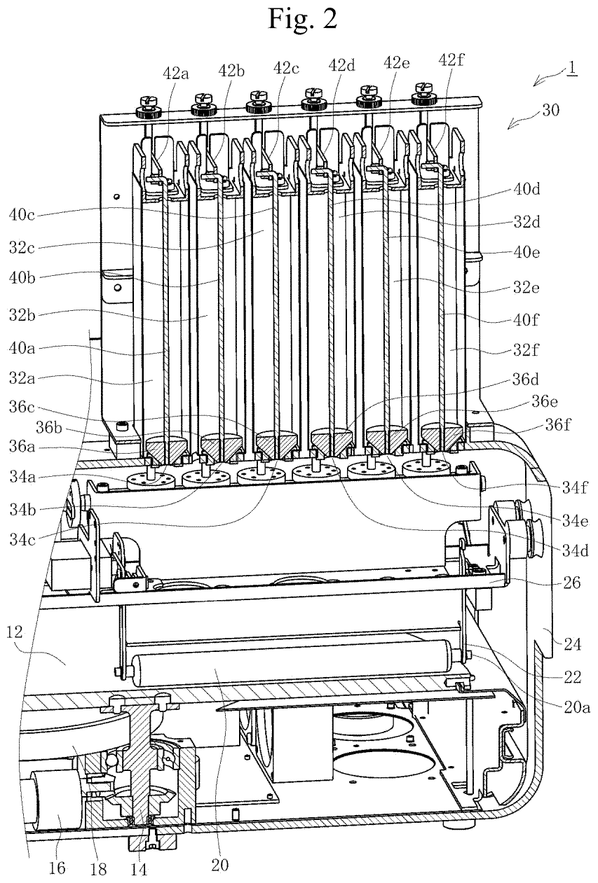

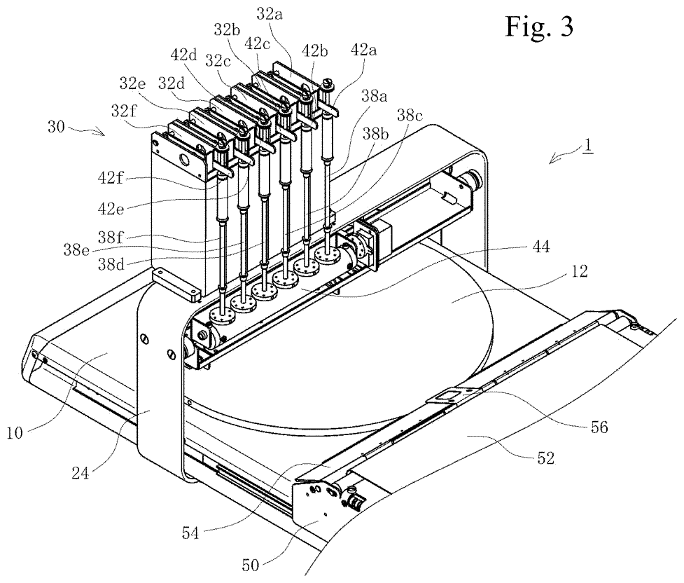

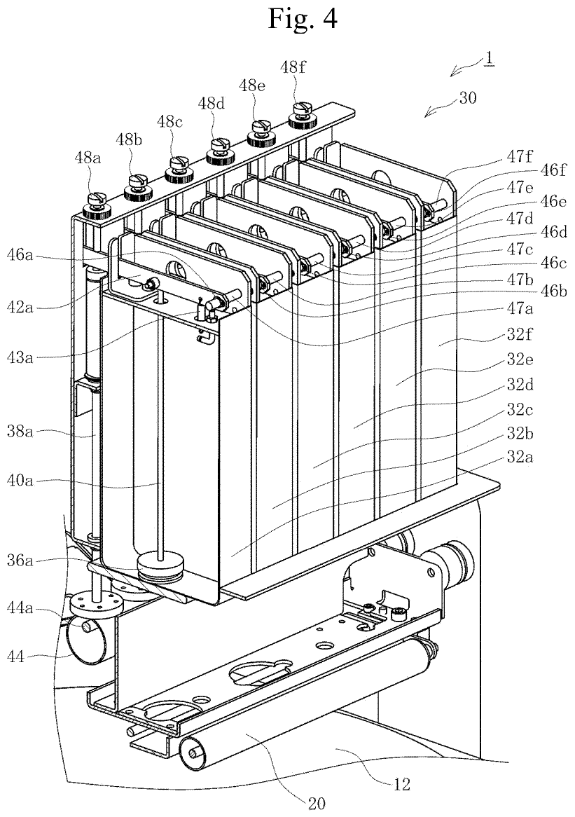

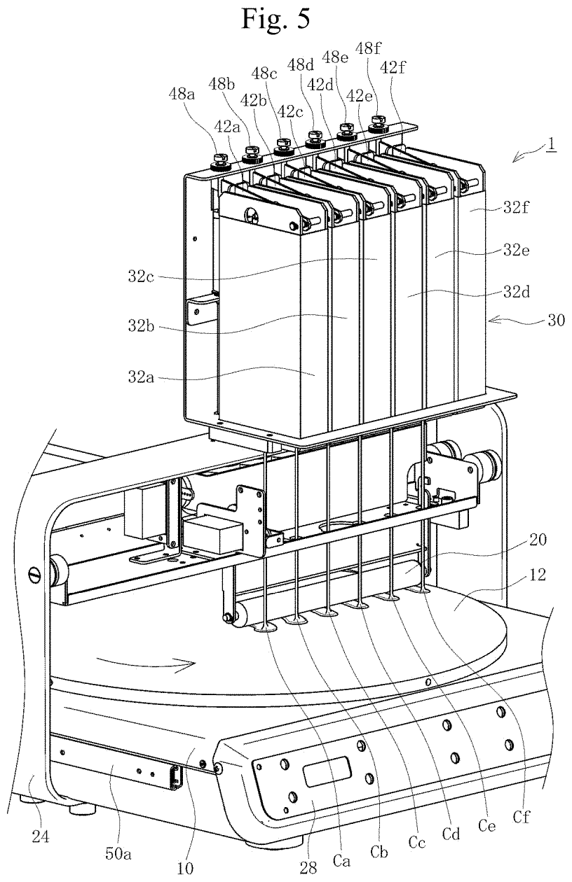

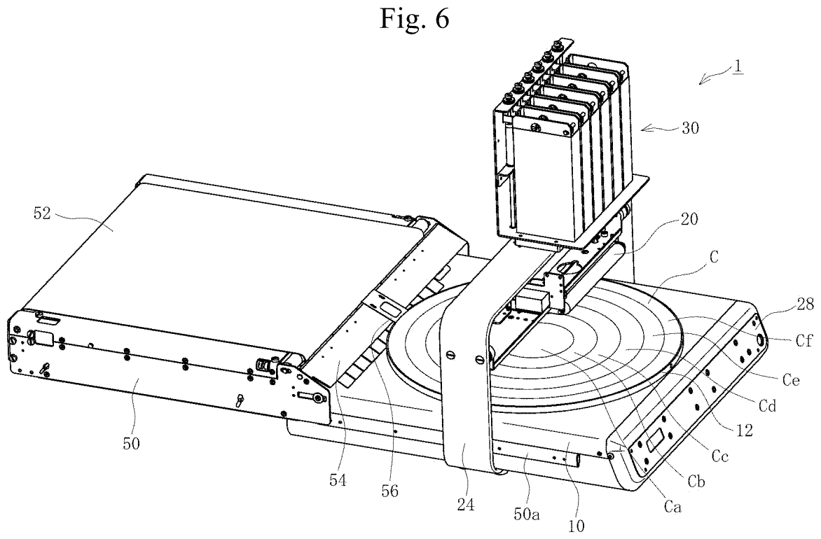

Embodiments of the present disclosure will be specifically described below with reference to the drawings. FIG. 1 is a perspective view illustrating an example of a food dough baking device according to the present disclosure. FIG. 2 is an explanatory diagram illustrating the dough dropper of the food dough baking device. FIG. 3 is an explanatory diagram illustrating the back side of the food dough baking device. FIG. 4 is an explanatory diagram illustrating the dough drop mouth opening and closing mechanism of the food dough baking device. FIG. 5 is an explanatory diagram illustrating operation of the dough dropper of the food dough baking device. FIG. 6 is an explanatory diagram illustrating operation of the food dough baking device.

Conceivable examples of foods that can be baked by the food dough baking device according to the present disclosure include crepe, galette, dosa, a Tianjin cracker, a tortilla, and a taco. However, the foods are not limited thereto as long as being foods obtained by thinly baking, on a griddle, food dough with flowability, obtained by adding water, milk, an egg, and/or the like to wheat flour, rice flour, buckwheat flour, mung bean flour, and/or the like and by mixing the wheat flour, rice flour, buckwheat flour, mung bean flour, and/or the like with water, milk, egg, and/or the like.

A food dough baking device 1 according to the present disclosure is a device of baking a food C made by thinly baking, on a griddle 12, different kinds of food doughs Ca to Cf with flowability, obtained by adding water and/or the like to wheat flour and/or the like and by mixing the wheat flour and/or the like with the water and/or the like. As illustrated in FIG. 1, the food dough baking device 1 includes a body 10, the griddle 12, a dough spreader 20, a dough dropper 30, a conveyor stage 50, and the like.

The kinds of the food doughs Ca to Cf may be optionally set, but are based on a difference in colors, tastes, flavors, materials, or combinations thereof.

The disk-shaped griddle 12 that can rotate about the center of circle as a rotation center in a heated state is disposed on the center of the upper surface of the body 10. In addition, the dough dropper 30 that drops the different kinds of the food doughs Ca to Cf to positions spaced in the radial direction of the griddle 12, corresponding to the food doughs Ca to Cf, respectively, and the dough spreader 20 that thinly spreads, on the entire surface of the griddle 12, the food doughs Ca to Cf dropped toward the griddle 12, are disposed above the griddle 12 on the body 10.

The griddle 12 has a structure in which a motor 16 is connected to a rotation shaft 14 disposed to protrude downward from the center of the griddle 12, and in which the griddle is rotated through the rotation shaft 14 by the motor 16, as illustrated in FIG. 2. Moreover, induction heating means 18 that passes current to a coil to allow the griddle 12 to generate heat is preferably disposed below the griddle 12 from the viewpoint of efficiently heating the rotating griddle 12 and of simplifying the structure.

The dough dropper 30 drops only predetermined amounts of the food doughs Ca to Cf to predetermined positions on the griddle 12. The cross-section structure of the dough dropper 30 is illustrated in FIG. 2. In the specific structure of the dough dropper 30, dough tanks 32a to 32f in which the different kinds of the food doughs Ca to Cf can be stored by kind are arranged above in the radial direction of the griddle 12.

Moreover, the dough dropper 30 is equipped with a mechanism of dropping dough by kind that drops the different kinds of the food doughs Ca to Cf stored in the dough tanks 32a to 32f to positions spaced in the radial direction of the griddle 12, corresponding to the food doughs Ca to Cf, respectively.

The mechanism of dropping dough by kind includes openable and closable dough drop mouths 34a to 34f through which the different kinds of the food doughs Ca to Cf can be dropped to the griddle 12 on a kind basis. The dough drop mouths 34a to 34f are disposed on the bottom surfaces of the dough tanks 32a to 32f, respectively, to allow the dough tanks 32a to 32f and the dough drop mouths 34a to 34f to be integrally formed.

Moreover, the mechanism of dropping dough by kind includes a dough drop mouth opening and closing mechanism that opens or closes the dough drop mouths 34a to 34f in conjunction with the rotation position of the griddle 12. The dough drop mouth opening and closing mechanism includes: a shaft portion that moves in an up-and-down manner; and valves 36a to 36f that open or close the dough drop mouths 34a to 34f in conjunction with the up-and-down movement of the shaft portion. The valves 36a to 36f open or close the dough drop mouths 34a to 34f in conjunction with the rotation position of the griddle 12.

FIG. 3 is a view illustrating the back side with respect to the front side, on which an operation panel 28 is present, of the food dough baking device 1 according to the present embodiment. A bar-shaped cam 44 with a bar shape that includes an eccentric rotation shaft 44a perpendicular to the rotation shaft 14 of the griddle 12 and extending in the radial direction of the griddle 12, and that rotates in conjunction with the rotation position of the griddle 12 is included below the back surfaces of the dough tanks 32a to 32f.

FIG. 4 illustrates the cross-section structure of the dough tank 32a of the food dough baking device 1. The dough tanks 32b to 32f also have a similar structure. The shaft portion includes cam-side shafts 38a to 38f, valve-side shafts 40a to 40f, and stay members 42a to 42f Specifically, the stay members 42a to 42f with a horizontally long bar shape are disposed above the dough tanks 32a to 32f The stay members 42a to 42f include one ends, in which holes 46a to 46f are opened, and are swingably pivotally supported by shafts 47a to 47f that pass through the holes 46a to 46f and extend in the radial direction of the griddle 12 above the front sides of the dough tanks 32a to 32f. Moreover, the upper ends of the cam-side shafts 38a to 38f are pivotally supported on the other ends of the stay members 42a to 42f Moreover, the upper ends of the valve-side shafts 40a to 40f are pivotally supported between both the ends of the stay members 42a to 42f.

The cam-side shafts 38a to 38f disposed on the back surfaces of the dough tanks 32a to 32f include lower ends abutting on the outer peripheral surface of the bar-shaped cam 44, and move in an up-and-down manner along the corrugation of the outer peripheral surface of the bar-shaped cam 44 rotating eccentrically.

Moreover, the valve-side shafts 40a to 40f that can move in an up-and-down manner are disposed in the interiors of the dough tanks 32a to 32f Commonly, the stay members 42a to 42f are biased in the direction of being pulled down by springs 43a to 43f, to thereby allow the valves 36a to 36f disposed on the lower ends of the valve-side shafts 40a to 40f to block the dough drop mouths 34a to 34f In contrast, for dropping dough, the valves 36a to 36f move upward with upward movement of the valve-side shafts 40a to 40f to open each of the dough drop mouths 34a to 34f, to thereby enable the food doughs Ca to Cf to be dropped on the griddle 12. The amount of the opening of each of the dough drop mouths 34a to 34f varies according to a difference between the heights of the upward movement of the valve-side shafts 40a to 40f, and therefore, the amounts of the food doughs Ca to Cf dropped on the griddle 12 can be allowed to differ from each other.

The cam-side shafts 38a to 38f include the lower ends abutting on the outer peripheral surface of the bar-shaped cam 44, and therefore move in an up-and-down manner along the corrugation of the outer peripheral surface of the bar-shaped cam 44 in conjunction of the movement of the rotation of the eccentric rotation shaft 44a of the bar-shaped cam 44 by a driving device such as a motor. The up-and-down movement of the cam-side shafts 38a to 38f allow the stay members 42a to 42f linked to the upper ends of the cam-side shafts 38a to 38f to swing on the shafts 47a to 47f as supporting points. In conjunction therewith, the valve-side shafts 40a to 40f of which the upper ends are linked to the stay members 42a to 42f move in an up-and-down manner. The up-and-down movement of the valve-side shafts 40a to 40f enables the valves 36a to 36f on the lower ends of the valve-side shafts 40a to 40f to open or close the dough drop mouths 34a to 34f.

In the food dough baking device 1 according to the present embodiment, the food doughs Ca to Cf are dropped using the dough dropper 30 and the bar-shaped cam 44 including the eccentric rotation shaft 44a, and therefore, the food doughs Ca to Cf can be simultaneously dropped toward the griddle 12. However, it is not necessary to simultaneously drop the food doughs Ca to Cf.

The mechanism for dropping the food doughs Ca to Cf to the griddle 12 may be a motor or the like directly connected to each of the stay members 42a to 42f without using the bar-shaped cam 44. The dough drop mouth opening and closing mechanism may have a structure in which the dough drop mouths 34a to 34f are opened or closed by a solenoid valve or the like. When such structures are used, each difference between time periods, for which the dough drop mouths 34a to 34f are opened, enables the amounts of the food doughs Ca to Cf dropped on the griddle 12 to differ from each other.

With regard to the drop positions of the food doughs Ca to Cf from the dough drop mouths 34a to 34f toward the griddle 12, the food doughs Ca to Cf may be dropped directly on the griddle 12. Alternatively, the food doughs Ca to Cf may be temporarily dropped to the dough spreader 20, and dropped on the griddle 12 along the rotation of the dough spreader 20.

Moreover, the shaft portion includes, on the upper ends of the cam-side shafts 38a to 38f, swing amount adjustment mechanisms 48a to 48f that set the amounts of swing of the stay members 42a to 42f with respect to the amounts of up-and-down movement of the cam-side shafts 38a to 38f The amounts of opening or closing of the dough drop mouths 34a to 34f can vary due to the setting of the swing amount adjustment mechanisms 48a to 48f In the case of setting the manual rotation of the screws in the assuming swing amount adjustment mechanisms 48a to 48f, the angles of the stay members 42a to 42f linked to the cam-side shafts 38a to 38f can be changed by adjusting the length of each of the cam-side shafts 38a to 38f by the rotation of each screw. As a result, in a simple structure, the amount of swing of each of the stay members 42a to 42f can be easily changed, and can also be finely adjusted. As a result, the amount of opening or closing of each of the dough drop mouths 34a to 34f can be changed to adjust the amount of each of the food doughs Ca to Cf dropped on the griddle 12.

The swing amount adjustment mechanisms 48a to 48f are not particularly limited as long as the swing amount adjustment mechanisms have a structure in which the height at which the stay members 42a to 42f and the cam-side shafts 38a to 38f are linked to each other can be changed to change the angles of the stay members 42a to 42f when biasing by the springs 43a to 43f is canceled. Conceivable examples of means for changing a linkage position include means for changing a position, in which a screw is manually rotated, as well as means for changing a position, in which a screw is electrically rotated by a servomotor or the like, and means for changing a position by disposing a plurality of grooves in the cam-side shafts 38a to 38f to change the positions of mating with the stay members 42a to 42f.

In the dough dropper 30 according to the present embodiment, adjustment can be made so that the amounts of the food doughs Ca to Cf dropped on the griddle 12 vary according to the dough drop mouths 34a to 34f, however, it is not necessary to change the drop amounts in the radial direction of the griddle 12. However, the amounts of the food doughs Ca to Cf dropped on the griddle 12 are preferably allowed to differ from each other according to the dough drop mouths 34a to 34f The amounts of the food doughs Ca to Cf dropped on the griddle 12 may be changed according to the dough drop mouths 34a to 34f on the basis of, for example, a desired pattern including concentric layers formed of the different kinds of the food doughs.

The dough tanks 32a to 32f and the mechanism of dropping dough by kind are preferably disposed based on each of the different kinds of the food doughs Ca to Cf. However, the structure of the dough dropper 30 is not limited to the structure described in the present embodiment, but may be a structure in which the food doughs Ca to Cf can be dropped on the griddle 12.

The six dough tanks 32a to 32f are described in the present embodiment. However, two or more dough tanks may be disposed. In addition, formation of the dough tanks 32a to 32f in a removable cartridge type facilitates replacement and cleaning of the dough tanks.

As illustrated in FIG. 2, the dough spreader 20 has a cylindrical or columnar shape rotatable along a shaft 20a, and is disposed to lie on a side of the dough spreader in a state in which the shaft 20a is located in the radial direction of the griddle 12, and in which a predetermined spacing is disposed between the dough spreader and the griddle 12. Specifically, a base table 24 having a gate shape is erected above the body 10 and just above the griddle 12, and the dough spreader 20 is rotatably pivotally supported by supporters 22 hanging down from both the sides at the radial position of the griddle 12 on the lower surface of a plate 26 disposed in the lower area of the base table 24. The surface of the dough spreader 20 is desirably coated with a material (for example, fluorine resin) that prevents the food doughs Ca to Cf from sticking to the surface. A distance between the griddle 12 and the dough spreader 20 is set as appropriate based on the thickness of the food C to be baked. With regard to the positions of the dough spreader 20 and the dough drop 30, the dough spreader 20 is arranged below the dough dropper 30 in the drawings, but a positional relationship with each other is optional.

As illustrated in FIG. 1, the conveyor stage 50 is disposed at a side position of the body 10 of the food dough baking device 1, has a generally square gate shape viewed from the upper surface, and is configured to be able to slide along rails 50a, disposed on both sides of the body 10, to overlap above the body 10. Moreover, a conveyor belt 52 disposed to be able to be driven by a motor is disposed on the entire top surface of the conveyor stage 50. In addition, a slope guide plate 54 that hangs down to slope from the end of the conveyor belt 52 toward the griddle 12 is disposed on the side, closer to the body 10, of the conveyor stage 50 in the state of being apart from the upper part of the body 10.

Moreover, the food dough baking device 1 includes, on the outer periphery of the griddle 12, an end peeling piece 56 located between the griddle 12 and the food doughs Ca to Cf (food C) dropped on the griddle 12. The end peeling piece 56 may be disposed at any position of the outer periphery of the griddle 12. A structure may be made in which the end peeling piece 56 can be inserted and removed between the griddle 12 and the food doughs Ca to Cf (food C) dropped on the griddle 12 by peeling piece driving means.

The operation of the food dough baking device 1 configured as described above will now be described by taking production of crepe as an example. First, six kinds of crepe doughs Ca to Cf with flowability and, for example, different colors, obtained by adding milk and an egg to wheat flour and by mixing the wheat flour with the milk and the egg, are loaded in the dough tanks 32a to 32f, respectively. A state is achieved in which the crepe doughs Ca to Cf can be dropped from the dough drop mouths 34a to 34f of the dough dropper 30 onto the griddle 12. The griddle 12 is heated to a temperature sufficient for baking the crepe C by the induction heating means 18 while rotating the griddle 12.

In a state in which the warmed griddle 12 is rotated, the crepe doughs Ca to Cf are dropped from the dough drop mouths 34a to 34f of the dough dropper 30 toward the griddle 12, as illustrated in FIG. 5. Specifically, the bar-shaped cam 44 is rotated by the motor in conjunction with the rotation position of the griddle 12, to allow the cam-side shafts 38a to 38f, of which the lower ends abut on the outer peripheral surface of the bar-shaped cam 44, to move upward along the corrugation of the outer peripheral surface of the bar-shaped cam 44. In conjunction therewith, one ends of the stay members 42a to 42f linked to the upper ends of the cam-side shafts 38a to 38f move upward on, as supporting points, the shafts 47a to 47f passing through the holes 46a to 46f of the other ends of the stay members 42a to 42f. Furthermore, the valve-side shafts 40a to 40f of which the upper ends are linked to the stay members 42a to 42f move upward. With the upward movement, the valves 36a to 36f disposed on the lower ends of the valve-side shafts 40a to 40f also move upward to open the dough drop mouths 34a to 34f, and to drop the crepe doughs Ca to Cf to positions spaced in the radial direction of the griddle 12, corresponding to the crepe doughs Ca to Cf, respectively.

After the crepe doughs Ca to Cf in predetermined amounts have been dropped, with the rotation of the bar-shaped cam 44, the cam-side shafts 38a to 38f move downward, and the stay members 42a to 42f biased by the springs 43a to 43f also move downward on the shafts 47a to 47f as supporting points. With the downward movement of the valve-side shafts 40a to 40f in conjunction therewith, the valves 36a to 36f also move downward to close each of the dough drop mouths 34a to 34f, and to end the drop of the crepe doughs Ca to Cf.

The amounts of the doughs dropped from each of the dough drop mouths 34a to 34f to the griddle 12 can be changed by setting of the screws 48a to 48f disposed on the upper ends of the cam-side shafts 38a to 38f With regard to the amounts of the crepe doughs Ca to Cf dropped to the griddle 12, it is preferable for baking the crepe C with a uniform thickness that the amount of the crepe dough from the dough drop mouth 34a close to the center of the rotation of the griddle 12 is allowed to be the largest, and the amounts are reduced with increasing a distance from the center of the rotation of the griddle 12. The rotational speed of the griddle 12 is determined in consideration of the states of the crepe doughs Ca to Cf, temperature, the thickness of the crepe C intended to be baked, and the like.

The crepe doughs Ca to Cf dropped on the rotating griddle 12 are spread in a thin-disk shape to form one piece of the crepe C as a whole by the dough spreader 20. It will be appreciated that the crepe doughs Ca to Cf are simultaneously baked because the crepe doughs Ca to Cf are spread in the thin-disk shape on the heated griddle 12.

In the food dough baking device 1 according to the present embodiment, the dough spreader 20 swings toward the rotation direction of the griddle 12, and therefore, the crepe doughs Ca to Cf can be more uniformly spread in the shape of one concentric thin disk.

As illustrated in FIG. 6, the different kinds of the crepe doughs Ca to Cf are spread in the shape of one thin disk in which each dough forms a layer concentrically with respect to the center of the rotation of the griddle 12, the dough spreader 20 is then moved away upward, and subsequently, the crepe doughs are baked into the crepe C while rotating the griddle 12. At a stage where the crepe C has been baked, the end peeling piece 56 is inserted into between the crepe C and the griddle 12 (a state is also acceptable in which the end peeling piece 56 is not inserted after the baking but the end peeling piece 56 is preset at this position from the beginning). As a result, the end peeling piece 56 lifts the outer peripheral portion of the crepe C. Then, the conveyor stage 50 moves to the position of about 80% of the griddle 12 while allowing the slope guide plate 54 to enter between the griddle 12 and the crepe C. Thereafter, when the crepe C runs onto the slope guide plate 54 and runs onto the conveyor belt 52 rotated by the motor, the crepe C is raised onto the conveyor stage 50, and then is peeled off from the griddle 12. The baking of the crepe C in which the concentric layers with the six colors are formed due to differences in the colors of the crepe doughs Ca to Cf is ended by putting the conveyor stage 50, on which the crepe C is placed, back to the original position of the conveyor stage 50.

In the present embodiment, the different six kinds of the crepe doughs Ca to Cf are stored in the six dough tanks. However, the number of the kinds is not limited to six. In the food dough baking device 1, for example, different two kinds of crepe doughs are stored in two dough tanks, and crepe C in which the two kinds of the crepe doughs form layers concentrically with respect to the rotation center of the griddle 12 may be baked.

FIGS. 1 to 6 illustrate the food dough baking device 1 in which the dough tanks 32a to 32f and the mechanism of dropping dough by kind are integrally formed. However, it is also possible to separate the dough tanks 32a to 32f and the mechanism of dropping dough by kind, and to link the dough tanks and the dough drop mouths to each other by a flow path such as a tube.

For example, different kinds of food doughs Ca and Cb are stored in two dough tanks A and B, respectively. Three tubes A1, A2, and A3 from the dough tank A, and three tubes B1, B2, and B3 from the dough tank B are linked to six dough drop mouths 34a to 34f arranged to be radially spaced above the griddle 12, respectively. It is conceivable that the tubes are linked to the dough drop mouths 34a to 34f in various orders of the tubes A1, B1, A2, B2, A3, and B3, the tubes A1, A2, B1, A3, B2, and B3, and the like from the rotation center toward the outer periphery of the griddle 12.

In accordance with the food dough baking device 1 as described above, including: the disk-shaped griddle 12 disposed to be able to rotate about the center of a circle as a rotation center in a heated state; the dough dropper 30 that drops the different kinds of the food doughs Ca to Cf to positions spaced in the radial direction of the griddle 12, corresponding to the food doughs Ca to Cf, respectively; and the dough spreader 20 that thinly spreads, on the entire surface of the griddle 12, the food doughs Ca to Cf dropped toward the griddle 12, wherein the different kinds of the food doughs Ca to Cf are baked while spreading the food doughs Ca to Cf in a thin-disk shape on the rotating griddle 12 by the dough spreader 20 so that each food dough forms a layer concentrically with respect to the center of the rotation of the griddle 12, whereby the food doughs Ca to Cf can be baked so that such feeling that the food doughs Ca to Cf are thinly hand-spread and hand-baked is reproducible, and the food C including the different kinds of the food doughs Ca to Cf, each forming a layer concentrically with respect to the center of the rotation of the griddle 12, can be baked.

The dough dropper 30 includes: the dough tanks 32a to 32f in which the different kinds of the food doughs Ca to Cf can be stored based on the kinds; and the mechanism of dropping dough by kind that drops the different kinds of the food doughs Ca to Cf stored in the dough tanks 32a to 32f to positions spaced in the radial direction of the griddle 12, corresponding to the food doughs Ca to Cf, respectively, whereby the food doughs Ca to Cf of which the kinds such as colors, tastes, flavors, materials, and the like are different from each other can be stored in the plurality of the dough tanks, and therefore, a food that exhibits high design properties with regard to appearance, eating quality, food texture, flavor, and the like, has increased variations, and concentrically forms layers can be baked.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2018-143128, filed on Jul. 31, 2018, the entire disclosure of which is incorporated by reference herein.

### INDUSTRIAL APPLICABILITY

As described above, in accordance with the present disclosure, there can be provided a food dough baking device and a food dough baking method, in which food doughs can be baked so that such feeling that the food doughs are thinly hand-spread and hand-baked is reproducible, and in which a food including the different kinds of the food doughs, each forming a layer concentrically with respect to the center of rotation of a griddle, can be baked.

### REFERENCE SIGNS LIST

1 Food dough baking device
10 Body
12 Griddle
14 Rotation shaft
16 Motor
18 Induction heating means
20 Dough spreader
20a Shaft
22 Supporter
24 Base table
26 Plate
28 Operation panel
30 Dough dropper
32a to 32f Dough tank
34a to 34f Dough drop mouth
36a to 36f Valve
38a to 38f Cam-side shaft
40a to 40f Valve-side shaft
42a to 42f Stay member
43a to 43f Spring
44 Bar-shaped cam
44a Eccentric rotation shaft
46a to 46f Hole
47a to 47f Shaft
48a to 48f Swing amount adjustment mechanism (screw)
50 Conveyor stage
50a Rail
52 Conveyor belt
54 Slope guide plate
56 End peeling piece

1. A food dough baking device for roundly and thinly baking food dough, the food dough baking device comprising:
a disk-shaped griddle disposed to be able to rotate about a center of a circle as a rotation center in a heated state;
a dough dropper that drops different kinds of food doughs to positions spaced in a radial direction of the griddle, corresponding to the food doughs, respectively; and
a dough spreader that thinly spreads, on an entire surface of the griddle, the food doughs dropped toward the griddle,
wherein the different kinds of the food doughs are baked while being spread in a thin-disk shape on the rotating griddle by the dough spreader so that each food dough forms a layer concentrically with respect to a center of rotation of the griddle.

2. The food dough baking device according to claim 1,
wherein the dough dropper comprises:
dough tanks in which the different kinds of the food doughs can be stored based on the kinds; and
a mechanism of dropping dough by kind that drops the different kinds of the food doughs stored in the dough tanks to positions spaced in a radial direction of the griddle, corresponding to the food doughs, respectively.

3. The food dough baking device according to claim 2, wherein
the mechanism of dropping dough by kind comprises openable and closable dough drop mouths through which the different kinds of the food doughs can be dropped to the griddle on a kind basis; and
the dough drop mouths are disposed on bottom surfaces of the dough tanks to allow the dough tanks and the mechanism of dropping dough by kind to be integrally formed.

4. The food dough baking device according to claim 3, wherein the mechanism of dropping dough by kind comprises a dough drop mouth opening and closing mechanism that opens or closes the each dough drop mouth in conjunction with a rotation position of the griddle.

5. A food dough baking device for roundly and thinly baking food dough, the food dough baking device comprising:
a disk-shaped griddle disposed to be able to rotate about a center of a circle as a rotation center in a heated state;
a dough dropper that drops different kinds of food doughs to positions spaced in a radial direction of the griddle, corresponding to the food doughs, respectively;
a dough spreader that thinly spreads, on an entire surface of the griddle, the food doughs dropped toward the griddle; and
a bar-shaped cam with a bar shape that comprises an eccentric rotation shaft perpendicular to a rotation shaft of the griddle and extending in a radial direction of the griddle, and that rotates in conjunction with a rotation position of the griddle,
wherein
the different kinds of the food doughs are baked while being spread in a thin-disk shape on the rotating griddle by the dough spreader so that each food dough forms a layer concentrically with respect to a center of rotation of the griddle,
the dough dropper comprises:
dough tanks in which the different kinds of the food doughs can be stored based on the kinds; and
a mechanism of dropping dough by kind that drops the different kinds of the food doughs stored in the dough tanks to positions spaced in a radial direction of the griddle, corresponding to the food doughs, respectively,
the mechanism of dropping dough by kind comprises openable and closable dough drop mouths through which the different kinds of the food doughs can be dropped to the griddle on a kind basis,
the dough drop mouths are disposed on bottom surfaces of the dough tanks to allow the dough tanks and the mechanism of dropping dough by kind to be integrally formed,
the mechanism of dropping dough by kind comprises a dough drop mouth opening and closing mechanism that opens or closes the each dough drop mouth in conjunction with a rotation position of the griddle,
the dough drop mouth opening and closing mechanism comprises:
a shaft portion that abuts on an outer peripheral surface of the bar-shaped cam and moves in an up-and-down manner along a corrugation of the outer peripheral surface of the bar-shaped cam; and
a valve that opens or closes the dough drop mouth in conjunction with up-and-down movement of the shaft portion; and
the valve opens or closes the dough drop mouth in conjunction with the rotation position of the griddle.

6. The food dough baking device according to claim 5,
wherein the shaft portion comprises:
a cam-side shaft that comprises a lower end abutting on the outer peripheral surface of the bar-shaped cam, and that moves in an up-and-down manner along the corrugation of the outer peripheral surface of the bar-shaped cam;
a valve-side shaft that comprises a lower end on which the valve is disposed; and
a stay member that comprises a horizontally long bar shape, that comprises one end which is swingably pivotally supported, and that comprises another end on which an upper end of the cam-side shaft is pivotally supported, an upper end of the valve-side shaft being pivotally supported between both the ends; wherein
the cam-side shaft moves in an up-and-down manner in conjunction with movement of the bar-shaped cam, and the stay member swings and the valve-side shaft moves in an up-and-down manner due to up-and-down movement of the shaft by the cam; and
the valve opens or closes the dough drop mouth due to up-and-down movement of the valve-side shaft.

7. The food dough baking device according to claim 6, wherein
the shaft portion comprises a swing amount adjustment mechanism that sets an amount of swing of the stay member with respect to an amount of up-and-down movement of the cam-side shaft; and
an amount of opening or closing of the dough drop mouth varies due to setting of the swing amount adjustment mechanism.

8. The food dough baking device according to claim 2, wherein the dough tanks and the mechanism of dropping dough by kind are disposed based on each of the different kinds of the food doughs.

9. A food dough baking method for roundly and thinly baking food dough, the food dough baking method comprising:
dropping, toward a disk-shaped griddle disposed to be able to rotate about a center of a circle as a rotation center in a heated state, different kinds of food doughs to positions spaced in a radial direction of the griddle, corresponding to the food doughs, respectively; and
baking each food dough in a thin-disk shape on the rotating griddle so that each food dough forms a layer concentrically with respect to a center of rotation of the griddle, while thinly spreading, on an entire surface of the griddle, the food dough dropped toward the griddle by a dough spreader that comprises a cylindrical or columnar shape rotatable along a shaft and that is disposed to lie on a side of the dough spreader in a state in which the shaft is located in a radial direction of the griddle, and in which a predetermined spacing is disposed between the dough spreader and the griddle.

10. The food dough baking method according to claim 9, wherein the kinds of the food doughs are based on a difference in colors, tastes, flavors, materials, or combinations thereof.

11. The food dough baking device according to claim 3, wherein the dough tanks and the mechanism of dropping dough by kind are disposed based on each of the different kinds of the food doughs.

12. The food dough baking device according to claim 4, wherein the dough tanks and the mechanism of dropping dough by kind are disposed based on each of the different kinds of the food doughs.

13. The food dough baking device according to claim 5, wherein the dough tanks and the mechanism of dropping dough by kind are disposed based on each of the different kinds of the food doughs.

14. The food dough baking device according to claim 6, wherein the dough tanks and the mechanism of dropping dough by kind are disposed based on each of the different kinds of the food doughs.

15. The food dough baking device according to claim 7, wherein the dough tanks and the mechanism of dropping dough by kind are disposed based on each of the different kinds of the food doughs.
